(19) United States
(12) Patent Application Publication
(10) Pub. No.: US 2025/0305940 A1
(43) Pub. Date: Oct. 2, 2025

(54) System And Method For Color Measurement With Compensation For Second-Order Diffraction Error

(71) Applicant: DATACOLOR INC., Lawrenceville, NJ (US)

(72) Inventor: Zhiling Xu, Princeton Junction, NJ (US)

(73) Assignee: DATACOLOR INC., Lawrenceville, NJ (US)

(21) Appl. No.: 18/620,833

(22) Filed: Mar. 28, 2024

(51) Int. Cl. G01N 21/31

(52) U.S. Cl. CPC G01N 21/31

(57) ABSTRACT

In one or more implementations, an apparatus, system or method is provided to compensate for second-order diffraction error (SODE) in connection with color or light measurements of a sample. In one particular implementation, methods and systems have been developed to compensate for SODE in a spectrophotometer by using a set of wavelength-dependent compensation factors or called diffraction ratios. The compensation factors can be generated with a narrow-band light source that covers the lower part of the wavelength range of the spectrophotometer but not the higher part of the wavelength range where the second-order diffraction error occurs and can be applied to the raw data of the spectrophotometer to compensate for the second-order diffraction error.

### FIELD OF THE INVENTION

The present invention is directed to an apparatus, as well as systems and methods for measuring the color properties of a sample or item and evaluating the measurements to compensate for second-order diffraction errors present in the measurement data.

### BACKGROUND OF THE INVENTION

For a grating-based spectrophotometer, such as Datacolor's DC1000, due to second-order diffraction effect (SODE), the grating will deliver part of a certain wavelength (such as 350 nm) light towards the same direction of the light that has twice the wavelength (such as 700 nm). Therefore, if not compensated, when the light sent into the gratings has UV content in the range of 340 nm˜380 nm, the measured signal in the range of 680 nm˜760 nm will be distorted. This distortion is referred to as a second-order diffraction effect.

Traditionally, linear-variable long-pass filters are used to remove this second-order diffraction effect in practice and are manufactured into tens of thousands of spectrometers each year. However, these types of filters are expensive to produce and they require careful alignment to the detector during the spectrometer's manufacture.

Alternatively, as taught in patent granted to Xu et. al. (U.S. Pat. No. 9,188,486B1) (herein incorporated by reference in its entirety) a method was developed to compensate second-order diffraction error without using such a filter. However, the Method described by Xu et. al still requires certain production process changes during manufacturing.

Therefore, what is needed in the art is an analytical and methodological approach that allows for the correction of second-order diffraction effects in measurements without the need to add costly equipment or detailed maintenance routines. Furthermore, what is needed in the art are systems and methods that provide accurate color and light measurements while also compensate for second-order diffraction error in a low cost and easy to implement manner.

### SUMMARY OF THE INVENTION

In one or more implementations, an apparatus, system or method is provided to compensate for second-order diffraction error (SODE) in connection with color or light measurements of a sample. In one particular implementation, methods and systems have been developed to compensate for SODE in a spectrophotometer by using a set of wavelength dependent compensation factors or diffraction ratios. The compensation factors can be generated with a narrow-band light source that covers the lower part of the wavelength range of the spectrophotometer but not the higher part of the wavelength range where the second-order diffraction error occurs and can be applied to the raw data of the spectrophotometer to compensate for the second-order diffraction error. Alternatively, the compensation factors can be generated based on some empirical data, or some mathematical model, or training with both UV included and UV excluded data of one or more samples.

In a further arrangement, an apparatus for measuring the characteristics of a sample is provided, the apparatus comprising: a narrow-band light source; a spectrophotometer having at least a light measurement sensor and a processor, the light measurement sensor configured to measure the wavelengths of light within the narrow-band of the narrow-band light source to obtain a base signal at a first wavelength range, and a second-order signal at a second wavelength range, wherein the second wavelength range is greater than the first wavelength range and has no overlap with the first wavelength range; the processor configured to calculate a diffraction ratio value corresponding to a relationship of the second-order signal to the base signal; obtain a measurement of the sample using the spectrophotometer; and calculate corrected measurement value using at least the diffraction ratio value and the measurement signal value.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 details one or more components of the SODE measurement compensation system as described herein;

FIG. 2 details the modules of SODE measurement compensation system as described herein;

FIG. 3 provides a flow diagram of the SODE measurement compensation system as described herein;

FIG. 4 provides a chart detailing the first and second-order diffraction encountered by a sensor of the system or apparatus described.

FIG. 5 provides the results of a sample evaluation before and after second-order diffraction error compensation.

FIG. 6 provides the results of a sample evaluation using a particular approach to second-order diffraction error compensation.

FIG. 7 provides the results of a sample evaluation using a particular approach to second-order diffraction error compensation.

FIG. 8 provides the results of a sample evaluation using a particular approach to second-order diffraction error compensation.

### DETAILED DESCRIPTION OF CERTAIN EMBODIMENTS OF THE INVENTION

By way of overview and introduction, various embodiments of the apparatus, systems and methods described herein are directed to the compensation of second-order diffraction errors (SODE) in spectrophotometer measurements. In particular, the various embodiments of the systems, methods and apparatus described herein are directed to the correction of errors encountered in spectrophotometer measurements through the use a set of wavelength dependent compensation factors, herein referred to as diffraction ratios.

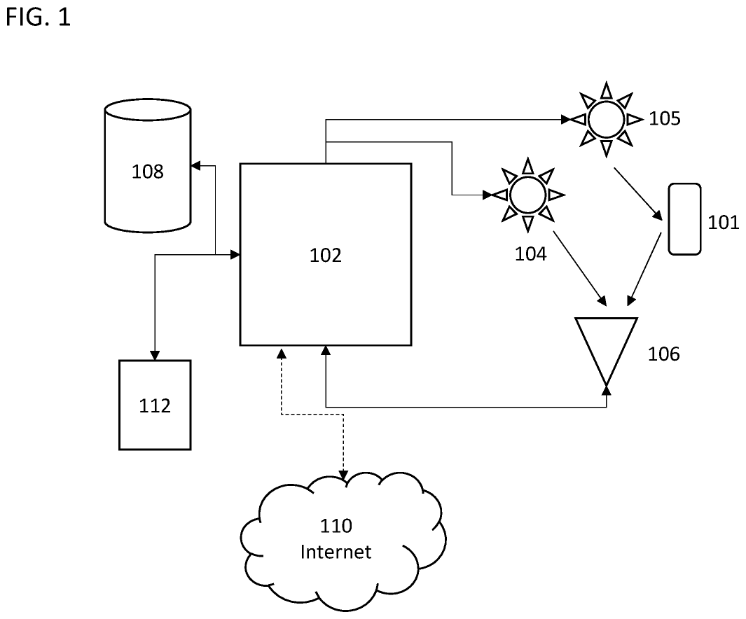

As shown, FIG. 1 illustrates the elements of one embodiment of a system or device for obtaining measurements of a sample that have been compensated for second-order diffraction error. In one arrangement such a system, device or apparatus includes a processor 102, at least a narrow-band light source 104, at least a broadband light source 105, a light measurement sensor 106, a database or data storage device 108, and a remote computer or display device 112.

In one or more particular implementations, the light sources 104 and 105 are integrated into the same instrument. In this configuration, light generated by light source 104 shines light onto the sample 101. This configuration is similar to how the light source 105 is configured to illuminate the sample 101. Alternatively, a single light source (not shown) can be configured to produce both the narrow-band light and the broadband light. For example, the output of an illuminant can be tuned or set to a desired range. Under such a configuration, the diffraction ratio can be obtained using light source 104 or 105, so long as the light source has been tuned or tailored to produce narrow-band light. Sample measurements are obtained using light source 105, and these measurements are then compensated using diffraction ratio generated using the light source 104.

In an alternative configuration, the light source 104 is configured to direct light from the light source 104 directly onto the light measurement sensor 106. In this configuration, the positioning of the light source 104 or its location in the instrument is separate and distinct from the location and position of light source 105. In this configuration, diffraction ratio values can be obtained using light 104. Here, sample measurements are still obtained using light 105, and can be compensated using diffraction ratio obtained using the light source 104.

In yet a further implementation, the light source 104 is not co-located in the measurement instrument. Here, only light source 105 is part of the instrument. A separate narrow-band light source 104 is used to generate the diffraction ratio. For example, an external light source 104 is used to direct light to the measurement sensor 106 to obtain the diffraction ratio. Once the diffraction ratio is obtained, sample measurements of a sample 101 can be obtained through the use of the diffraction ratio.

In one or more arrangements, the measurement device such as a spectrophotometer, is configured to measure a measurement target. In one particular implementation, the measurement target is a reflective or transmissive sample, such as a tile. In this configuration, the measurement device is configured to illuminate the sample and obtain a measurement. However, in some instances, the measurement target is an article that emits its own light. For example, where the measurement target is a lamp or display device, then the light from the light source 105 is not needed to obtain measurements. Here, the color measurement instrument is configured to measure the color of a light source such as a computer monitor or other display devices. In this implementation, the narrow band light source is still used to obtain the diffraction ratio, however there is no need to use the light source 105 to illuminate the measurement target.

It will be appreciated that in one or more arrangements, the elements presented in FIG. 1 can be incorporated into a single form factor, such as a commercial grade spectrophotometer. In another particular implementation, the elements described herein are separate or partially separate components that communicate with one another through wired or wireless connections.

With continued reference to FIG. 1, one or more illuminator(s) 104 is configured to emit light and cause such emitted light to either directly or indirectly illuminate the light measurement sensor 106. In one instance, the illuminator 104 is a single lighting element. However, in alternative implementations, the illuminator 104 is a collection of separate lighting devices that are configurable to produce a light with certain wavelength bands. For instance, the illuminator 104 can, in one implementation, be one or more discrete light emitting elements, such as LEDs or OLEDs; fluorescent, halogen, xenon, neon, fluorescent, mercury, metal halide, HPS, or incandescent lamps; or other commonly known or understood lighting sources.

In one arrangement, the illuminator 104 is one or more narrow-band LEDs. In one particular implementation, the illuminator 104 is a UV LED. In another arrangement, the illuminator 104 is a broadband light source configured with one or more UV band-pass filters positioned between the illuminator 104 and the measurement sensor 106.

With continued reference to FIG. 1, one or more illuminator(s) 105 is configured to emit light and cause such emitted light to either directly or indirectly illuminate the light measurement sensor 106. For instance, the illuminator 105 is configured to direct light towards a sample 101, which is then transmitted or reflected to the light measurement sensor 106.

In one instance, the illuminator 105 is a single lighting element. However, in alternative implementations, the illuminator 105 is a collection of separate lighting devices that are configurable to produce a light with certain wavelength bands. For instance, the illuminator 105 can, in one implementation, be one or more discrete light emitting elements, such as LEDs or OLEDs; fluorescent, halogen, xenon, neon, fluorescent, mercury, metal halide, HPS, or incandescent lamp; or other commonly known or understood lighting sources. In one arrangement, the illuminator 105 is one or more wide-band LEDs. In one or more implementations, the illuminator 105 is a light source incorporated into a spectrophotometer, such as Datacolor's DC1000.

In one or more implementations, the illuminator 104 or illuminator 105 includes a lens, filter, screen, enclosure, or other elements (not shown) that are utilized in combination with the light source of the illuminator 104 or illuminator 105 to direct a beam of illumination, at a given wavelength, to the light measurement sensor 106.

In a particular implementation, the illuminator 104 is operable or configurable by an internal processor or other control circuit. Alternatively, the illuminator 104 is operable or configurable by a remote processor or control device having one or more linkages or connections to the illuminator 104. As shown in FIG. 1, illuminator 104 is directly connected to a processor or computer 104.

Continuing with FIG. 1, light generated by the illuminator 104 is captured or measured by one or more measurement devices, such as the light measurement sensor 106. In one or more implementations, the illuminator or light source 104 is configured to send or shine light onto the wall of an integrating sphere (not shown). For example, where the measurement device includes an integrating sphere, the illuminator or light source 104 is configured to send light towards the inner surface of the integrating sphere. From there, light is then directed to the light measurement sensor 106. For example, where the measurement device is the DC1000, the integrating sphere is the integrating sphere found therein. In one or more particular implementations, where the illuminator 104 is not incorporated within the measurement device, the measurement device includes a door, window, trap, or other arrangement that allows light from an external illuminator to reach the light measurement device 106.

Here, the light measurement sensor 106 can be a color sensor or image capture device. For example, the light measurement sensor 106 is a scientific CMOS (Complementary Metal Oxide Semiconductor), CCD (charge coupled device), colorimeter, spectrometer, spectrophotometer, photodiode array, or other light sensing device and any associated hardware, firmware and software necessary for the operation thereof. In one particular implementation, the light measurement sensor 106 is a multi-channel spectral sensor or similar device. In one or more implementations, the light measurement sensor(s) 106 described herein, has multiple optical, NIR or other wavelength channels to evaluate a given wavelength range. However, other potential sensor configurations and wavelength channels having varying numbers of sensor channels and operational characteristics are understood and appreciated.

In a particular implementation, light measurement sensor 106 is the same sensor present in Datacolor's DC1000 spectrophotometer (the technical specifications of which are herein incorporated by reference in its entirety).

In a further arrangement, the light measurement sensor 106 is configured with diffraction grating and other optical components. For example, in one or more implementations, the light measurement sensor 106 includes high-pass filters.

In one or more configurations, the light measurement sensor 106 is configured to generate an output signal upon light striking a light sensing portion thereof. By way of non-limiting example, the light measurement sensor 106 is configured to output signals in response to light that has been directly or indirectly emitted by the illuminator (either 104 or 105).

For instance, light measurement sensor 106 is configured to generate a digital or analog signal that corresponds to the wavelength or wavelengths of light that are captured or received by the light measurement sensor 106. In one or more configurations, the light measurement sensor 106 is configured to output spectral information, RGB information, or another form of multi-wavelength data representative of light reflected off a sample 101.

As shown in FIG. 1 the light measurement sensor 106, or spectral sensor, is configured to transmit one or more measurements to a processing platform, such as processor 102. In one or more configurations, at least one light measurement sensor 106 is directly connected to processor 102. However, in one or more implementations, one or more light measurement sensors 106 (where there are multiple such sensors) are equipped or configured with network interfaces or protocols usable to communicate over a network, such as the internet. In this configuration, measurements made by light measurement sensors 106 are sent to a remote processor for evaluation and analysis.

Alternatively, at least one light measurement sensor 106 is connected to one or more computers or processors, such as processor 102, using standard interfaces such as USB, FIREWIRE, Wi-Fi, Bluetooth, and other wired or wireless communication technologies suitable for the transmission measurement data.

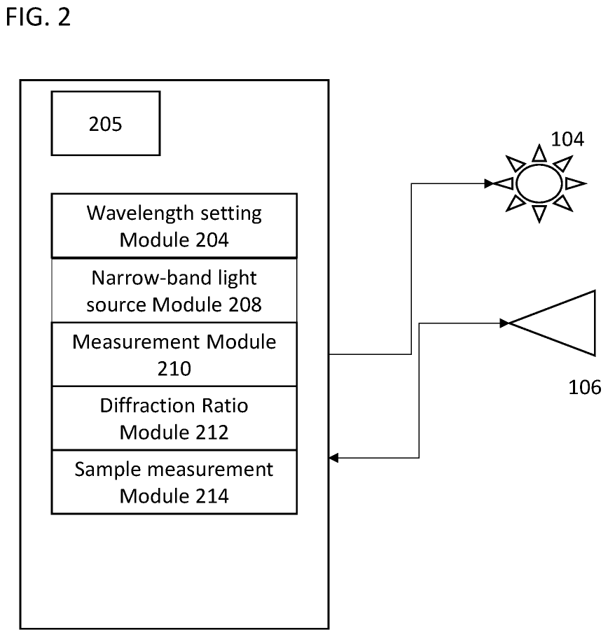

The output signals generated by the light measurement sensor 106 are transmitted to one or more processor(s) 102 for evaluation as a function of one or more hardware or software modules. As used herein, the term “module” refers, generally, to one or more discrete components that contribute to the effectiveness of the presently described systems, methods and approaches. Modules can include software elements, including but not limited to functions, algorithms, classes and the like. In one arrangement, the software modules are stored as software in memory 205 of processor 102, as shown in FIG. 2.

Modules can, in some implementations, include discrete or specific hardware elements. In one implementation, processor 102 is located within the same device or enclosure as the light measurement sensor 106. For example, bot the processor 102 and the light measurement sensor 106 are components of a spectrophotometer. However, in another implementation, processor 102 is remote or separate from the light measurement sensor 106 and communicates over one or more communication linkages.

In one configuration, processor 102 is configured through one or more software modules to generate, calculate, process, output or otherwise manipulate the output signals generated by the light measurement sensor 106.

In one implementation, processor 102 is a commercially available computing device. For example, processor 102 may be a collection of computers, servers, processors, cloud-based computing elements, micro-computing elements, computer-on-chip(s), home entertainment consoles, media players, set-top boxes, prototyping devices or “hobby” computing elements.

Furthermore, processor 102 can comprise a single processor, multiple discrete processors, a multi-core processor, or other type of processor(s) known to those of skill in the art, depending on the particular embodiment. In a particular example, processor 102 executes software code on the hardware of a custom or commercially available cellphone, smartphone, notebook, workstation or desktop computer configured to receive data or measurements captured by one or more light measurement sensors 106 either directly, or through a communication linkage.

Processor 102 is configured to execute a commercially available or custom operating system, e.g., Microsoft WINDOWS, Apple OSX, UNIX or Linux based operating system in order to carry out instructions or code. In a particular implementation, processor 102 is a computer, workstation, thin client or portable computing device such as an Apple iPad/iPhone® or Android® device or other commercially available mobile electronic device configured to receive and output data to or from database 108 and the light measurement sensor 106.

In one or more implementations, processor 102 is further configured to access various peripheral devices and network interfaces. For instance, processor 102 is configured to communicate over the internet with one or more remote servers, computers, peripherals or other hardware using standard or custom communication protocols and settings (e.g., TCP/IP, etc.).

Processor 102 may include one or more memory storage devices (memories). The memory is a persistent or non-persistent storage device (such as an IC memory element) that is operative to store the operating system in addition to one or more software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules. In one or more embodiments, the memory of processor 102 provides for the storage of application program and data files. One or more memories provide program code that processor 102 reads and executes upon receipt of a start, or initiation signal.

The computer memories may also comprise secondary computer memory, such as magnetic or optical disk drives or flash memory, that provide long term storage of data in a manner similar to a persistent memory device. In one or more embodiments, the memory of processor 102 provides for storage of an application program and data files when needed.

As shown in FIG. 1, processor 102 is configured to store data either locally in one or more memory devices. Alternatively, processor 102 is configured to store data, such as measurement data or processing results, in a local or remotely accessible database 108. The physical structure of database 108 may be embodied as solid-state memory (e.g., ROM), hard disk drive systems, RAID, disk arrays, storage area networks (“SAN”), network attached storage (“NAS”) and/or any other suitable system for storing computer data. In addition, database 108 may comprise caches, including database caches and/or web caches. Programmatically, database 108 may comprise flat-file data store, a relational database, an object-oriented database, a hybrid relational-object database, a key-value data store such as HADOOP or MONGODB, in addition to other systems for the structure and retrieval of data that are well known to those of skill in the art. Database 108 includes the necessary hardware and software to enable processor 108 to retrieve and store data within database 108.

In one implementation, each element provided in FIG. 1 is configured to communicate with one another through one or more direct connections, such as though a common bus. For example, when each of the components are contained within the same form-factor (such as a spectrophotometer), each component is connected to the processor 102, and optionally one another, through one or more direct electrical linkages. Alternatively, each element is configured to communicate with the others through network connections or interfaces, such as a local area network LAN or data cable connection. In an alternative implementation, the light measurement sensor 106, processor 102, and database 108 are each connected to a network 110, such as the internet, and are configured to communicate and exchange data using commonly known and understood communication protocols.

In one arrangement, processor 102 communicates with a local or remote display device 112 to transmit, displaying or exchange data. In one arrangement, the display device 112 and processor 102 are incorporated into a single form factor, such as a spectrometer, that includes an integrated display device. In an alternative configuration, the display device 112 is a remote computing platform such as a smartphone or computer that is configured with software to receive data generated and accessed by processor 102. For example, processor 102 is configured to send and receive data and instructions from a processor(s) of a remote display device 112.

This remote display device 112 includes one or more display devices configured to display data obtained from processor 102. Furthermore, display device 112 is also configured to send instructions to processor 102. For example, where processor 102 and the display device are wirelessly linked using a wireless protocol, instructions can be entered into display device 112 that are executed by the processor. Display device 112 includes one or more associated input devices and/or hardware (not shown) that allow a user to access information, and to send commands and/or instructions to processor 102. In one or more implementations, the display device 112 can include a screen, monitor, display, LED, LCD or OLED panel, augmented or virtual reality interface or an electronic ink-based display device.

It will be understood and appreciated that the components described here can be used to measure the light properties of a sample 101. In one or more implementations, sample 101 can be any type or form of physical article having color or spectral properties in need of analysis. For ease of reference and discussion, the foregoing descriptions the sample 101 refers to an article or material that has stable and uniform color and can be evaluated by currently available spectrophotometers.

In one or more further or alternative implementations, sample 101 is a calibration article. Here, the calibration article has specific properties making it suitable for stable measurements over time. For instance, sample 101 is a ceramic calibration tile. In one or more further implementations, sample 101 is a white ceramic calibration tile. However, in alternative configurations, sample 101 is a black calibration tile.

Those possessing an ordinary level of skill in the requisite art will appreciate that additional features, such as power supplies, power sources, power management circuitry, control interfaces, relays, adaptors, and/or other elements used to supply power and interconnect electronic components and control activations are appreciated and understood to be incorporated.

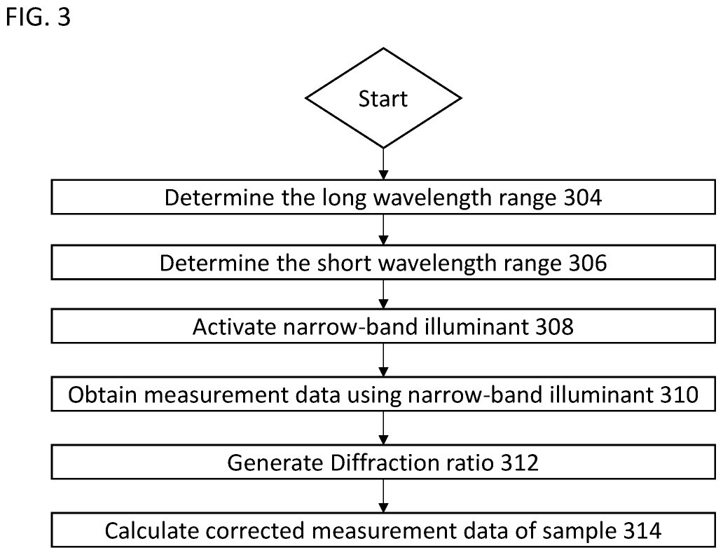

With particular reference to FIGS. 2 and 3, a process and method for calculating the second-order diffraction error in a measurement and correcting for such error is provided.

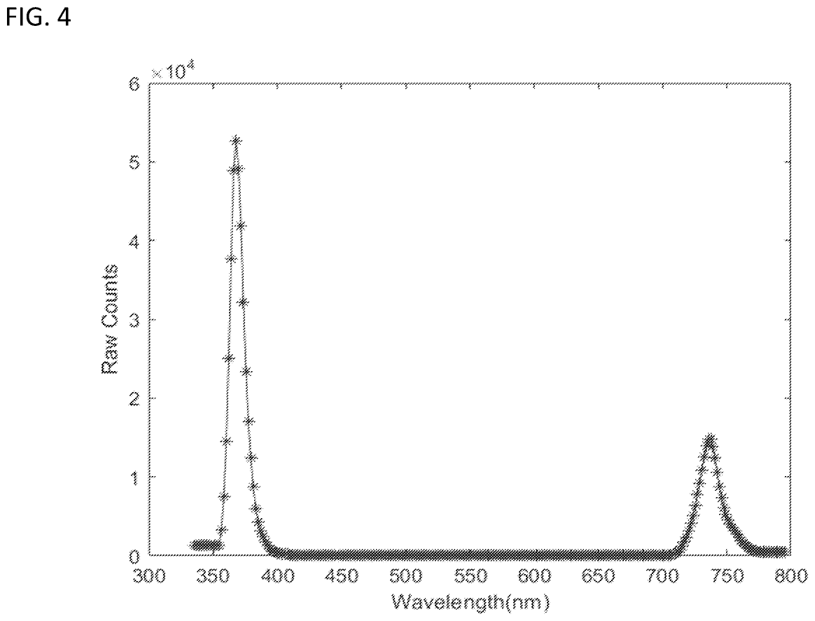

It will be appreciated that when the narrow-band light from a source (such as a narrow-band illuminator) reaches the grating-based spectro-sensor in the spectrophotometer, either directly or indirectly, it will generate a signal on the sensors as a function of wavelength, and both the base signal (first order) and the second-order diffraction signal will be captured, as shown in FIG. 4.

In order to compensate for the second-order diffraction, it is first necessary to define a range of wavelengths where the SODE arises. As shown in FIG. 3, a processor (such as processor 102) is configured by one or more modules to select or determine a start wavelength λL1 and end wavelength λL2 and all the intermediate wavelengths that will be compensated, as shown in step 304. It will be appreciated that the wavelength range λL1-λL2, (where L stands for long) is within the effective wavelength range of the measurement sensor 106. For example, the wavelength range λL1-λL2 is encompassed by the wavelength range that can be evaluated by a light measurement sensor of a particular make and model of spectrophotometer.

As shown in FIG. 2, in one arrangement, the processor 102 is configured by a wavelength determining module 204 to select a wavelength that is within the range of the measurement apparatus. In one arrangement, the wavelength determining module 204 configures the processor 102 to automatically select a wavelength range for L1-L2. Alternatively, the wavelength determining module 204 configures the processor 102 to receive user input that allows selection of a desired, calculated or custom L1-L2 range. In either case, the wavelength range for L1-L2 corresponds to the portion of the entire wavelength range of the spectral sensor where second order diffraction errors occur.

Next, one or more processors (such as processor 102) is configured by the wavelength determining module 204 to select a short wavelength range as shown in step 306. Here, the wavelength determining module 204 configures the processor 102 to automatically select a wavelength range for S1-S2 (where S stands for short). In one particular implementation the corresponding base wavelength λS1=λL1/2 and λS2=λL2/2, and all the intermediate short wavelengths are half values of the long wavelengths between λL1 and λL2. It will be appreciated that the wavelength range λS1˜λS2 is within the effective wavelength range of the measurement sensor 106.

In one or more further implementations, where the wavelengths of pixels in the short wavelength range (S1-S2) do not directly match that of the long wavelength range (L1-L2), for example, because the long wavelength divided by 2 falls between the wavelength of two adjacent pixels, the wavelength determining module 204 configures the processor 102 to perform an interpolation process to generate the proper wavelength match.

Once the long and short wavelengths have been selected, the processor 102 is configured by the narrow-band light source module 208 to activate the illuminate 104 and obtain measurement data from the light measurement sensor 106, as provided in step 308. Here, the illuminate 104 is a narrow-band, short-wavelength light source. For example, the range of wavelengths of light emitted by the illuminate 104 will be roughly equal to the S1-S2 wavelength range. Furthermore, the wavelength range of L1-L2 will be greater than and outside of the wavelength range emitted by the illuminate 104.

In one or more implementations where the illuminate 104 is configurable or tunable, the processor 102 is configured by the narrow-band light source module 208 to cause the illuminate 104 to be tuned or adjusted to produce the selected wavelength range set in step 306.

As shown in step 310, once the illuminate 104 is activated, the measurement results of the measurement sensor 106 are accessed by a processor configured by a measurement module 210. In this arrangement, the processor 102 is configured to receive data corresponding to the amount of light measured within the frequency ranges of S1-S2 (referred to herein as raw(λ_S1˜λ_S2)) as well as L1-L2 (referred to herein as raw (λ_L1˜λ_L2)). For example, the processor 102 is configured to receive electrical signals, data streams, packets or other forms of information and is configured to process this information into measurement values.

Once the raw values for both the S1-S2 and L1-L2 ranges have been obtained as in step 310, a diffraction ratio can be calculated, as in step 312. For example, a processor (such as processor 102) is configured by a diffraction ratio module 212 to calculate the diffraction ratio n(λ_L1˜λ_L2) for each wavelength between λ_L1 and λ_L2 according to:

$$η ( {λ}_{L 1} ∼ {λ}_{L 2} ) = raw ( {λ}_{L 1} ∼ {λ}_{L 2} ) / raw ( {λ}_{S 1} ∼ {λ}_{S 2} ) \qquad ( 1 )$$

Here, a processor (such as processor 102) is configured to obtain raw measurement values, such as raw counts, at each wavelength, λL1˜λL2. These wavelength values correspond to the second-order diffraction signal, and λS1˜λS2 measurement values correspond to the wavelength range of the base signal. By measuring a narrow-band light source, the processor is configured to isolate the second-order diffraction effects. For example, the processor configured by a diffraction ratio module 212 obtains measurements from the measurement device 106 when the measurement device 106 is illuminated by the narrow-band illuminator 104.

It will be appreciated that when measuring a reflective (or transmissive) signal of a sample, if there is no second-order diffraction error, the true signal would be raw_{True}(λ). However, due to the second-order diffraction error, the measured signal becomes:

$${raw}_{M e a s} ( {λ}_{L} ) = {raw}_{T r u e} ( {λ}_{L} ) + {raw}_{Diff} ( {λ}_{L} ) \qquad ( 2 )$$

where raw_{Diff}(λL) is the signal coming from wavelength λS and is directed to the direction of λL due to the second-order diffraction effect.

As noted, the relation between λS and λL can be expressed as:

$${λ}_{L} = {λ}_{S} * 2 \qquad ( 3 )$$

For a given wavelength λ_{L}, according to equation (1), the signal raw_{Diff}(λ_{L}) is determined by the base signal raw_{Base}(λ_{S}) and the second-order diffraction ratio η(λ_{L}), which can be expressed as:

$${raw}_{Diff} ( {λ}_{L} ) = {raw}_{B a s e} ( {λ}_{S} ) * η ( {λ}_{L} ) \qquad ( 4 )$$

From equations (2) and (4), the true signal at λ_{L} can be recovered according to:

$${raw}_{T r u e} ( {λ}_{L} ) = {raw}_{M e a s} ( {λ}_{L} ) - {raw}_{B a s e} ( {λ}_{S} ) * η ( {λ}_{L} ) \qquad ( 5 )$$

In equation (5), each item in the righthand side of the equation is measurable through operation of the spectrometer equipped with a broadband illuminate, such as illuminate 105, and a narrow-band illuminate, such as illuminate 104.

In one or more arrangements, the value can be saved in the memory or database 112 for retrieval and later use.

In one particular arrangement, after the diffraction ratio n(λ_L1˜λ_L2) is obtained, the measurement of the sample can be conducted. In one arrangement, the broadband light source (such as light source 105) is used. However, where a measurement target generates its own light, then the broadband light source is not needed to obtain the measurement of the measurement target.

For measurements made using a standard broadband light source (such as light source 105), the spectral sensor used to obtain the measurements is, in one arrangement, the spectral sensor of a spectrometer or other device typically used to obtain color measurements. For example, as shown in step 314, a sample 101 is measured using a broadband illuminate (such as illuminate 105) and the measurement sensor 106 generates measurement data across the wavelength range of the measurement sensor 106.

Once the measurements have been obtained for the sample 101 using the broadband illuminate, the measurement values for each of the wavelength between λ_L1 and λ_L2 can be corrected. For example, the processor 102 is configured by a sample measurement module 214 to provide the diffraction ratio and the raw measurement data as inputs to an error correction function. For example, the sample measurement module 214 configures the processor 102 to calculate the error corrected values for each wavelength between L1-L2 according to equation (5). For example, a suitably configured processor calculates the true values of the wavelengths between λ_L1 and λ_L2 according to:

$${raw}_{True} ( {λ}_{L} ) = {raw}_{M e a s} ( {λ}_{L} ) - {raw}_{B a s e} ( {λ}_{S} ) * η ( {λ}_{L} )$$

where raw_{Meas}(λ_{L}) is obtained from the direct measurement of the sample 101 in step 310. As noted, the value for the diffraction ratio is obtained by measuring the sample 101 with the narrow-band illuminator 104, or by directly illuminating the measurement sensor 106 with the narrow-band illuminator 104. Here, the sample measurement module 214 is configured to access the diffraction ratio value obtained using the narrow-band illuminator. Once the diffraction ratio is obtained, such as by accessing it from a computer memory, a measurement of the sample using a broadband illuminator 105 is conducted. The values for raw_{Base}(λ_{S}) and η(λ_{L}) are obtained from the measurement of the sample using the broadband illuminate 105, and used with the diffraction ratio to compensate for measurement errors within originating from the broadband light source.

Thus, one or more processors (such as processor 102) are configured by the error correction module 216 to adjust the measured values for wavelengths between λ_L1 and λ_L2 according to equation (5), as shown in step 316. For example, measurement values can be directly obtained as in steps 304-308. However, in an alternative configuration, prior measurement values for η(λ_{L}) can be accessed from one or more storage devices, such as database 108. However, even in the event that the measurement values are accessed from a stored memory, the measurements made to determine the diffraction ratio are made using the narrow-band illuminator 104, while the sample measurements are made using a broadband illuminator 105. In this configuration, the spectrometer or other color measurement device does not need to acquire a new measurement of the illuminate 104. Instead, by accessing a previously derived diffraction ratio, a suitably configured processor of a spectrophotometer can correct for the second-order diffraction errors according to a correction algorithm.

Regardless of how the compensated measurement values are obtained, once compensated, the compensated measurement value is then stored in the database 112 for further use or access.

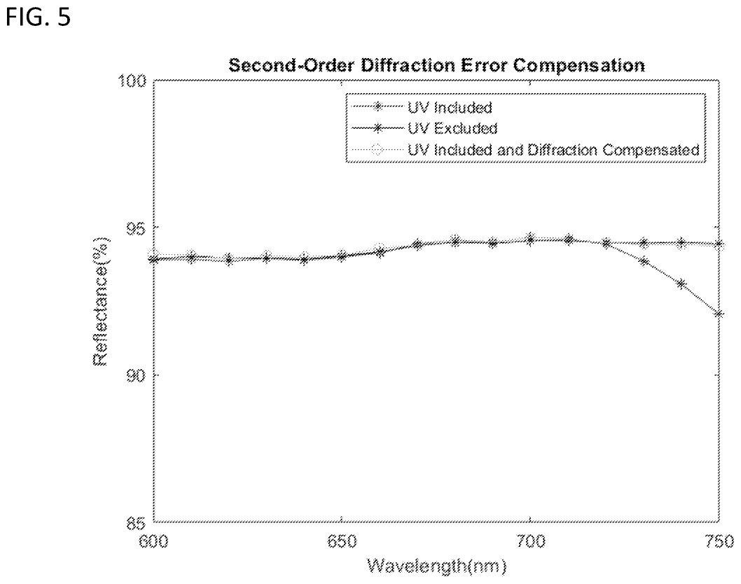

As shown in FIG. 5, the results of a measurement of a sample before and after second-order diffraction error compensation are provided. As shown with respect to FIG. 5, the approaches described herein provide new and useful technical solutions to technical problems encountered within the art. Furthermore, such solutions are achieved in a manner that improves the functionality of the current technology (improved measurement accuracy) and represents a technical advancement in the art.

Typically, for a normal color measurement such as reflective spectrum, a color measurement system needs to be calibrated by measuring a black trap and a white tile, and then a sample can be measured. In each of the measurements, both a sample channel signal and a reference channel signal are captured in this arrangement. The reference channel signal is used to compensate for any light source fluctuations. In each of the calibration and measurement, the signals are wavelength dependent, and may be contaminated by second-order diffraction error. Therefore, to compensate for such an error, equation (5) can be used to recover the uncontaminated signal for each of the calibration and measurement.

It will be appreciated that the wavelength range where second-order diffraction error occurs is usually small compared to the whole effective wavelength range of the spectrophotometer, therefore focus can be directed on the compensation of that wavelength range.

It will be further appreciated that for a typical spectrophotometer that covers wavelength range of 360 nm to 750 nm, the UV-Excluded result has no second-order diffraction error because the base signal at UV range is 0. Thus, as shown in FIG. 5, the UV Excluded result is not contaminated and doesn't require compensation. Also shown in FIG. 5, the UV Included result is contaminated because of the second-order diffraction error. It can be seen that with second-order diffraction compensation as described herein, the second-order diffraction errors have been eliminated, particularly at 730 nm, 740 nm and 750 nm wavelengths.

In one or more further or alternative implementations, the narrow-band light source, such as illuminator 104 is not directly integrated into a spectrophotometer or other color measurement device platform. Instead, the diffraction ratio n (λ_{L1}˜λ_{L2}) is measured separately. For example, in a configuration setup where the measurement sensor 106, illuminate 105 and processor 102 are part of the same spectrophotometer device, a separate illuminate 104 can be used. For example, light originating from a separate lighting setup, such as one or more narrow-band light sources (either one or more LEDs, or bandpass filtered light sources, or the combination of them) covering the wavelength range of λS1˜λS2 are provided as a lighting source. Such a lighting source can be a specifically designed light source for this purpose, or a general light source that is repurposed for the functionality described herein.

In this configuration, the grating-based spectral sensor of the spectrometer (such as but not limited to measurement sensor 106) of the spectrophotometer is set to receive the light from this separate light source or illuminate and capture both the base signal and the second-order diffraction signal.

Similar to previously described processed, in this configuration the diffraction ratio η(λ_{L1}˜λ_{L2}) can be calculated from the captured signals, and be stored for later use. For example, the processor (such as processor 102) of the spectrophotometer is configured to store the raw data in a database (such as but not limited to database 112) or other data storage device.

Once the diffraction ratio is obtained, the measurement results of the spectrophotometer can be compensated to eliminate the second-order diffraction error, as described in the prior implementations.

In yet a further configuration, the diffraction ratio η(λ_{L1}˜λ_{L2}) is not directly measured. Instead, some empirical values can be used, or some values based on a certain mathematical model can be used. Those values can be stored in the spectrophotometer, and can be used to compensate for second-order diffraction error as described in the first implementation. By way of non-limiting example, one or more processors are configured to access a database, table or other data structure that provides the diffraction ratio of each interested wavelength. Here the diffraction ratio is based, at least partially, on one or more empirical values, such as one or more previous measurement results indicating the relationship between the base signal and the second-order signal. For another example, the diffraction ratio can be calculated using a mathematical equation that is also based on one or more previous experimental results. Such results, across a number of measurements and wavelengths, can then be reduced to a mathematical equation or function. This derived equation or function provides the diffraction ratio for use in the steps described herein.

In yet another implementation, the diffraction ratio n can be obtained by comparing the UV included spectral result and UV excluded spectral result of one or more samples. By adding some initial values to the diffraction ration and compensating for the raw measurement results of the one or more samples, the UV included spectral result can be updated, and compared to the UV excluded spectral result of the same one or more samples. For example, and in no way limiting, the initial values can be a set of diffraction ratios that has been previously used in other similar instruments, or the average diffraction ratio of the first 100 units of the same instruments produced. By optimizing the diffraction ratio, the error between the UV included spectral result and UV excluded spectral result between the one or more samples can be reduced to a predefined threshold, and the final diffraction ratio can be stored in the spectrophotometer and used later to compensate for the second-diffraction error of other samples in a regular measurement.

The optimization method can be based on one or more traditional optimization methods such as a Gene Algorithm or other algorithm directed to solve complex search and optimization problems. Alternatively, the optimization can be accomplished or carried out using one or more artificial intelligence or machine learning tools, such as convolutional neural networks.

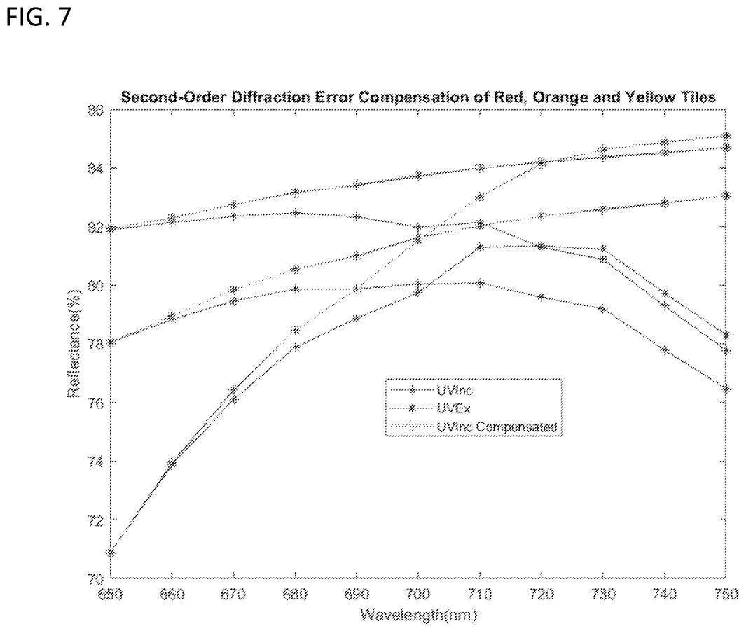

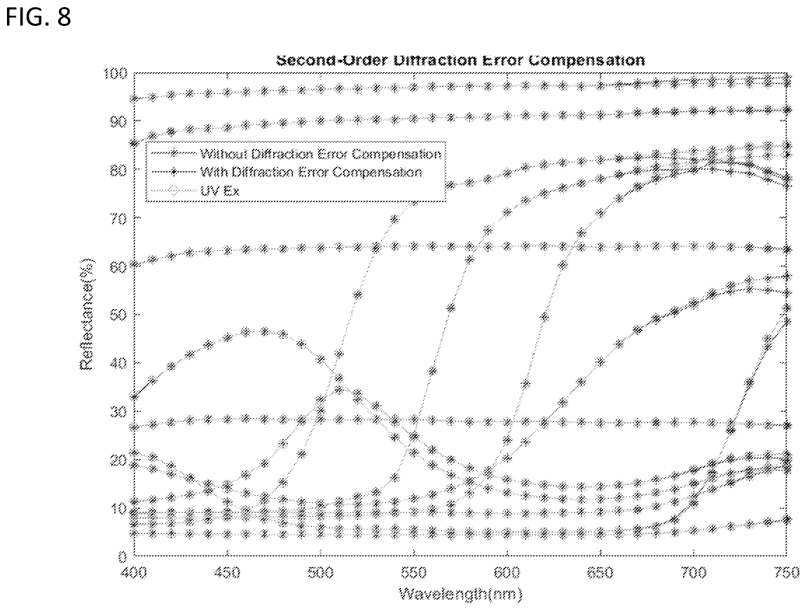

In a further arrangement, a DC1000 instrument (or other form of spectrophotometer) is used to measure a spectralon (or another fluoropolymer that has suitably high diffuse reflectance) and 12 BCRA tiles, under both UV included and UV excluded configurations. By comparing the two results, the processor 102 can be configured to optimize the diffraction ratio mathematically to match the two sets of spectra of red, orange and yellow tiles, as shown in FIG. 7. Furthermore, FIG. 8 illustrates the outcome when the same diffraction ratio optimized above is applied to all the 12 BCRA samples. As shown in FIG. 8, diffraction error can be compensated using an optimized diffraction ratio and the results match that of UV Excluded result significantly well for all the samples using the same set of diffraction error ratios trained from the result of red, orange and yellow tiles.

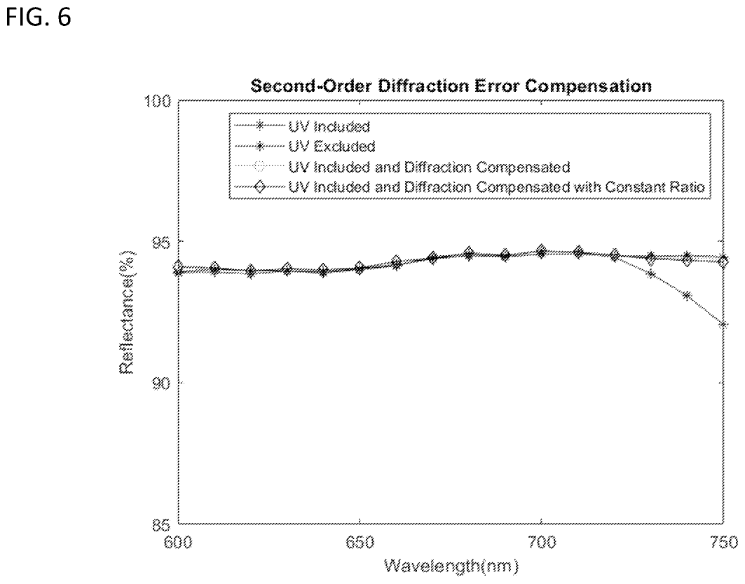

In yet another implementation, the diffraction ratio n can be approximated as a constant. That is, the diffraction ratio does not change with the wavelengths, i.e. η=constant. While such an approach to second-order diffraction error correction may not be as performant as a variable value for the diffraction ratio, it can largely reduce the error in most cases. The plot in FIG. 6 shows the comparison of compensation with a measured diffraction ratio and a constant diffraction ratio, and the difference is negligible.

While this specification contains many specific embodiment details, these should not be construed as limitations on the scope of any embodiment or of what can be claimed, but rather as descriptions of features that can be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter have been described in this specification. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Publications and references to known registered marks representing various systems cited throughout this application are incorporated by reference herein. Citation of any above publications or documents is not intended as an admission that any of the foregoing is pertinent prior art, nor does it constitute any admission as to the contents or date of these publications or documents. All references cited herein are incorporated by reference to the same extent as if each individual publication and reference were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the claims that follow, the respective features recited in those claims, and by equivalents of such features.

What is claimed is:

1. An apparatus for measuring the characteristics of a measurement target, comprising:
a narrow-band light source; and
a measurement device having at least one light measurement sensor and at least one processor, wherein the at least one processor is configured to:
calculate a diffraction ratio value corresponding to a ratio of a second-order diffraction signal to a first diffraction signal at a plurality of wavelengths within the wavelength range of the narrow-band light source;
obtain one or more measurement values of the measurement target using the measurement device; and
calculate a second-order-diffraction-error compensated measurement value for the measurement target using at least the one or more measurement values and the diffraction ratio value.

2. The apparatus of claim 1, wherein the diffraction ratio value is calculated by obtaining, from the at least one light measurement sensor that is illuminated by light from the narrow-band light source, measurement values corresponding to: (i) the wavelengths of light within the wavelength range of the narrow-band light source to obtain a first diffraction signal at a first wavelength range, and (ii) a second-order diffraction signal at a second wavelength range outside the wavelength range of the narrow band light source.

3. The apparatus of claim 1, further comprising a broad-band light source of the spectrophotometer configured to illuminate the sample.

4. The apparatus of claim 1, wherein the second wavelength range is greater than the first wavelength range.

5. The apparatus of claim 1, wherein the relationship of a given wavelength in the first wavelength range (λS) to a given wavelength in the second wavelength range (λL) can be expressed as: λ_{L}=λ_{S}*2.

6. The apparatus of claim 4, wherein the processor is configured to calculate the diffraction ratio η(λ_L1˜λ_L2) for each wavelength between λ_L1 and λ_L2 according to: η(λ_{L1}˜λ_{L2})=raw(λ_{L1}˜λ_{L2})/raw(λ_{S1}˜λ_{S2}), where λ_{S1}˜λ_{S2} is the range of wavelengths in the first wavelength range.

7. The apparatus of claim 4, where the diffraction ratio η(λ_L1˜λ_L2) is a constant.

8. The apparatus of claim 1, where the calculated second-order-diffraction-error compensated measurement value is stored in at least one data storage device.

9. The apparatus of claim 1, wherein the measurement of the sample is corrected according to raw_{True}(λ_{L})=raw_{Meas}(λ_{L})−raw_{Base}(λ_{S})*η(λ_{L}), where raw_{Meas}(λ_{L}) is the measurement values at λ_{L}, η(λ_{L}) is the diffraction ratio, and raw_{Base}(λ_{S}) is a measured value of a base signal obtained during measurement of the sample.

10. The apparatus of claim 3, wherein the wavelengths of pixels in the long wavelength range (L1-L2) cannot be divided to produce a whole number, the processor is further configured to implement an interpolation algorithm to generate the short wavelength values.

11. The apparatus of claim 1, where the narrow band light source is configured as a separate device remote from the spectrophotometer and is used to obtain the diffraction ratio of the spectral sensor in the measurement device.

12. The apparatus of claim 1, wherein the measurement device is a spectrometer used to measure the measurement target.

13. The apparatus of claim 11, wherein the narrow-band light source is a lamp or LED or some other types of light sources.

14. An apparatus for measuring the characteristics of a sample, comprising: a light measurement device having at least a light measurement sensor and at least one processor, the light measurement device configured by code executed by the processor to:
obtain a measurement of the sample using the light measurement sensor;
access from one or more local or remote data storage devices, a stored base value obtained from the same measurement of the sample and a diffraction ratio value, and
calculate, using the measurement value, the stored base value from the same measurement, and the diffraction ratio, a compensated measurement value for the sample.

15. The apparatus of claim 14, wherein the processor is further configured to store the compensated measurement value to one or more remote data storage devices.

16. The apparatus of claim 14, where the diffraction ratio is a constant.

17. The apparatus of claim 14, wherein the measurement of the sample is corrected according to raw_{True}(λ_{L})=raw_{Meas}(λ_{L})−raw_{Base}(λ_{S})*η(λ_{L}), where raw_{Meas}(λ_{L}) is the measurement values at λ_{L}, η(λ_{L}) is the diffraction ratio, and raw_{Base}(λ_{S}) is the base value at λ_{S} from the same measurement.

18. A method for compensating second-order diffraction when measuring the light properties of a sample, the method comprising:
obtaining one or more measurement values, using a spectrophotometer having at least a light measurement sensor and a processor, of the light properties of the sample,
Accessing one or more stored diffraction ratio values and one or more base signal values;
calculating, using the obtained one or more measurement values, diffraction ratio values and base signal values, error corrected measurement values for the light properties of the sample, wherein the error corrected measurement values have substantially less second-order diffraction errors than the one or more measurement values.

19. The method of claim 18, wherein the measurement of the sample is corrected according to raw_{True}(λ_{L})=raw_{Meas}(λ_{L})−raw_{Base}(λ_{S})*η(λ_{L}), where raw_{Meas}(λ_{L}) is the measurement values at λ_{L}, η(λ_{L}) is the diffraction ratio, and raw_{Base}(λ_{S}) is the base value at λ_{S} from the same measurement.

20. The method of claim 18, wherein the one or more diffraction ratio values are obtained by:
illuminating the light measurement sensor with a narrow-band light source;
measuring wavelengths of light within a narrow-band of the narrow-band light source to obtain a first diffraction signal at a first wavelength range, and a second-order diffraction signal at a second wavelength range;
calculating a diffraction ratio value corresponding to a ratio of the second-order diffraction signal to the first diffraction signal at a plurality of wavelengths within the narrow-band;
obtaining one or more measurement values of the sample using the spectrophotometer; and
calculating a second-order-diffraction-error compensated measurement value for the sample using at least the one or more measurement values and the diffraction ratio value.
